(19) United States
(12) Patent Application Publication
(10) Pub. No.: US 2005/0259554 A1
(43) Pub. Date: Nov. 24, 2005

(54) Objective optical system and optical pickup device using it

(75) Inventors: Toshiaki Katsuma, Tokyo (JP); Masao Mori, Saitama City (JP); Tetsuya Ori, Koshigaya City (JP); Yu Kitahara, Saitama City (JP)

Correspondence Address: ARNOLD INTERNATIONAL, P. O. BOX 129, GREAT FALLS, VA, 22066-0129, US

(73) Assignee: FUJINON CORPORATION

(21) Appl. No.: 11/128,279

(22) Filed: May 13, 2005

(30) Foreign Application Priority Data
May 19, 2004 (JP) 2004-148997

(51) Int. Cl. G11B 7/00

(52) U.S. Cl. 369/112.23; 369/112.01; 369/44.23

(57) ABSTRACT

An objective optical system is formed of a diffractive optical element with a diffractive surface formed on a planar ‘virtual surface’ (i.e., a surface that would be planar but for the diffractive structure) and an objective lens for focusing three collimated light beams of three different wavelengths at three different numerical apertures onto desired positions of three different recording media with substrates of different thicknesses, such as an AOD, a DVD, and a CD, that introduce different amounts of spherical aberration in the focused beams. The objective optical system provides compensating spherical aberration to the three light beams while keeping equal the distance between the diffractive optical element and the objective lens, and focuses second-order diffracted light of one wavelength and first-order diffracted light of the other two wavelengths. An optical pickup device includes the objective optical system, the recording media, and a light source supplying the three light beams.

### TECHNICAL FIELD OF THE INVENTION

The present invention relates to an objective optical system for an optical recording medium that, when recording or reproducing information, efficiently focuses light of any one of three different wavelengths onto an appropriate corresponding recording medium according to standardized characteristics such as the numerical aperture of the objective optical system used, the wavelength of the light selected, and the substrate thickness of the optical recording medium. The present invention also relates to an objective optical system for an optical recording medium where a diffractive optical element is used to diffract light in order to efficiently focus light of any one of the three wavelengths onto a corresponding one of the three optical recording media, and it also relates to an optical pickup device using such an objective optical system.

### BACKGROUND OF THE INVENTION

In recent years, a variety of optical recording media have been developed and optical pickup devices that carry out recording and reproducing using two alternative types of optical recording media have been known. For example, devices that carry out recording or reproducing with either a DVD (Digital Versatile Disk) or a CD (Compact Disk including CD-ROM, CD-R, CD-RW) have been practically used. For these two optical recording media, the DVD uses visible light having a wavelength of approximately 657 nm for improved recording densities while, by contrast, the CD is required to use near-infrared light having a wavelength of approximately 790 nm because there are some recording media that have no sensitivity to visible light. Accordingly, a single optical pickup device, known as a two-wavelength-type pickup device, uses incident light of these two different wavelengths. The two optical recording media described above require different numerical apertures (NA) due to their different features. For example, the DVD is standardized to use a numerical aperture of about 0.60-0.65 and the CD is standardized to use a numerical aperture in the range of 0.45-0.52. Additionally, the thicknesses of the two types of recording disks, including the thicknesses of the protective layers or substrates made of polycarbonate (PC), are different. For example, the DVD may have a substrate thickness of 0.6 mm and the CD may have a substrate thickness of 1.2 mm.

As described above, because the substrate thickness of the optical recording medium is standardized and differs according to the type of optical recording medium, the amount of spherical aberration introduced by the substrate is different based on the different standardized thicknesses of the substrates of the different recording media. Consequently, for optimum focus of each of the light beams on the corresponding optical recording medium, it is necessary to optimize the amount of spherical aberration in each light beam at each wavelength for recording and reproducing. This makes it necessary to design the objective lens with different focusing effects according to the light beam and recording medium being used.

Additionally, in response to rapid increases of the data capacity required each day, the demand for an increase in the recording capacity of recording media has been strong. It is known that the recording capacity of an optical recording medium can be increased by using light of a shorter wavelength and by increasing the numerical aperture (NA) of an objective lens. Concerning a shorter wavelength, the development of a semiconductor laser with a shorter wavelength using a GaN substrate (for example, a semiconductor laser that emits a laser beam of 408 nm wavelength) has advanced to the point where this wavelength is now practical for use.

With the development of short wavelength semiconductor lasers, research and development of AODs (Advanced Optical Disks), also known as HD-DVDs, that provide approximately 20 GB of data storage on a single layer of a single side of an optical disk by using short wavelength light is also progressing. As the AOD standard, the numerical aperture and disk thickness are selected to be about the same as those of DVDs, with the numerical aperture (NA) and disk substrate thickness for an AOD being set at 0.65 and 0.6 mm, respectively.

Furthermore, research and development of Blu-ray disk (BD) systems that use a shorter wavelength of disk illuminating light, similar to AOD systems, has progressed, and the standardized values of numerical aperture and disk thickness for these systems are completely different from the corresponding DVD and CD values, with a numerical aperture (NA) of 0.85 and a disk substrate thickness of 0.1 mm being standard. Unless otherwise indicated, hereinafter, AODs and Blu-ray disks collectively will be referred to as “AODs.”

Accordingly, this makes it necessary to design the objective lens with different focusing effects according to the light beam and recording medium being used for AODs, as well as CDs and DVDs, in order to compensate for the amounts of spherical aberration introduced by the different standardized thicknesses of the substrates of the different recording media for light beams at each wavelength for recording and reproducing.

The development of an optical pickup device that can be used for three different types of optical recording media, such as AODs, DVDs and CDs as described above, has been demanded and objective optical systems for mounting in such devices have already been proposed. For example, an objective optical system that includes a diffractive optical element with a refractive surface and a diffractive surface and a biconvex lens is described on page 1250 of Extended Abstracts, 50^{th} Japan Society of Applied Physics and Related Societies (March, 2003). The objective optical system described in this publication is designed so that: second-order diffracted light from the diffractive optical element is used for a BD optical recording medium; first-order diffracted light from the diffractive optical element is used for a DVD optical recording medium; and also first-order diffracted light from the diffractive optical element is used for a CD optical recording medium. The spherical aberration that is created by and varies with the thickness of the protective layer (i.e., the substrate) of each optical recording medium is corrected by using a converging or diverging light to enter the diffractive optical element, and chromatic aberration is also improved relative to a single component lens by the diffractive optical element having a convergent-type diffractive surface as its front surface (namely, the surface on the light source side), and a concave surface as its rear surface.

In the technology described in the above-mentioned publication, in order to reduce the generation of coma associated with a shift of the objective optical system relative to an incident light beam, when recording or reproducing information to or from the BD, the design is such that the light incident on the diffractive optical element is converging light. Further, when recording or reproducing information to or from the DVD or the CD, the design is such that the light incident on the diffractive optical element is diverging light.

However, there presently is strong demand for a compact device that provides greater freedom in positioning the objective optical system within the recording and reproducing device. In order to achieve this, it is necessary to create a design such that collimated light, rather than diverging or converging light, be incident on the objective optical system for all three of the light beams that are being used. Additionally, if diverging or converging light is incident on the diffractive optical element, there are problems of the diffraction efficiency being reduced due to the angle of incidence of the light rays on the diffractive grooves of the diffractive optical element being tilted from the desired angle of incidence, and there are problems of the stability of the tracking being decreased.

### BRIEF SUMMARY OF THE INVENTION

The present invention relates to an objective optical system for optical recording media that can efficiently focus each of three light beams on a corresponding one of three optical recording media with different technical standards of the substrate thickness, the wavelengths of the three light beams, and the numerical aperture (NA) of the objective optical system for each of the three light beams. Using three collimated light beams of three different wavelengths in the objective optical system of the present invention allows for increased freedom in selecting the position of the objective optical system and improved diffraction efficiency of the light beams, and concurrently increases the stability of the tracking. The present invention further relates to such an objective optical system with the diffractive optical element being also a lens element of the objective optical system. The present invention further relates to an optical pickup device using this objective optical system.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1A-1C are schematic diagrams that depict cross-sectional views of the objective optical system of an embodiment of the present invention, with FIG. 1A showing the operation of the objective optical system when used with a first optical recording medium 9a, with FIG. 1B showing the operation of the objective optical system when used with a second optical recording medium 9b, and with FIG. 1C showing the operation of the objective optical system when used with a third optical recording medium 9c;

FIGS. 2A-2C illustrate wavefront aberration profiles of the light beams of three wavelengths that are focused to spots by the objective optical system of the embodiment of FIGS. 1A-1C of the present invention, with FIG. 2A illustrating the wavefront aberration profile of the light beam of the first wavelength that is focused to a spot for the first optical recording medium, FIG. 2B illustrating the wavefront aberration profile of the light beam of the second wavelength that is focused to a spot for the second optical recording medium, and FIG. 2C illustrating the wavefront aberration profile of the light beam of the third wavelength that is focused to a spot for the third optical recording medium; and

FIG. 3 is a schematic diagram of an optical pickup device using the objective optical system of FIGS. 1A-1C.

### DETAILED DESCRIPTION

The present invention relates to an objective optical system for optical recording media that can be used to focus each of three different light beams of three different wavelengths, λ1, λ2, and λ3, from a light source to a different desired position for each of the first, second and third optical recording media of substrate thicknesses, T1, T2, and T3, respectively, for recording and reproducing information.

The objective optical system includes, from the light source side: a diffractive optical element with one surface of the diffractive optical element being a diffractive surface defined by a phase function Φ, as will be discussed in detail later; and an objective lens of positive refractive power with both surfaces being rotationally symmetric aspheric surfaces. The phase function Φ is chosen so that the objective optical system is able to focus each of the three different light beams of three different wavelengths, λ1, λ2, and λ3, at a different desired position for each of the first, second and third optical recording media of substrate thicknesses, T1, T2, and T3, respectively.

The objective optical system is constructed so that collimated light of each wavelength, λ1, λ2, and λ3, diffracted by the diffractive optical element is efficiently focused onto the desired position of the corresponding optical recording media of substrate thickness, T1, T2, and T3, respectively. In order for this to occur at all three wavelengths, the diffraction order of the diffracted light of at least one wavelength must be different from the diffraction order of the diffracted light of at least one other wavelength.

Additionally, the three wavelengths, the diffraction orders of light used, the numerical apertures NA1, NA2, and NA3 of the objective optical system associated with the wavelengths λ1, λ2, and λ3, respectively, and the substrate thickness of T1, T2, and T3, respectively, of the three recording media are selected so that the numerical aperture of the objective optical system is never larger for light of a larger wavelength being used and so that the substrate thickness is never smaller for light of a larger wavelength being used.

In summary, throughout the following descriptions the following definitions apply:
NA1 is the numerical aperture of the objective optical system for light of the first wavelength λ1 that is focused on the optical recording medium of substrate thickness T1,
NA2 is the numerical aperture of the objective optical system for light of the second wavelength λ2 that is focused on the optical recording medium of substrate thickness T2, and
NA3 is the numerical aperture of the objective optical system for light of the third wavelength λ3 that is focused on the optical recording medium of substrate thickness T3.

Additionally, in the objective optical system of the present invention, the following conditions are satisfied:
λ1<2<λ3 Condition (1)
NA1≧NA2>NA3 Condition (2)
T1<T2<T3 Condition (3).

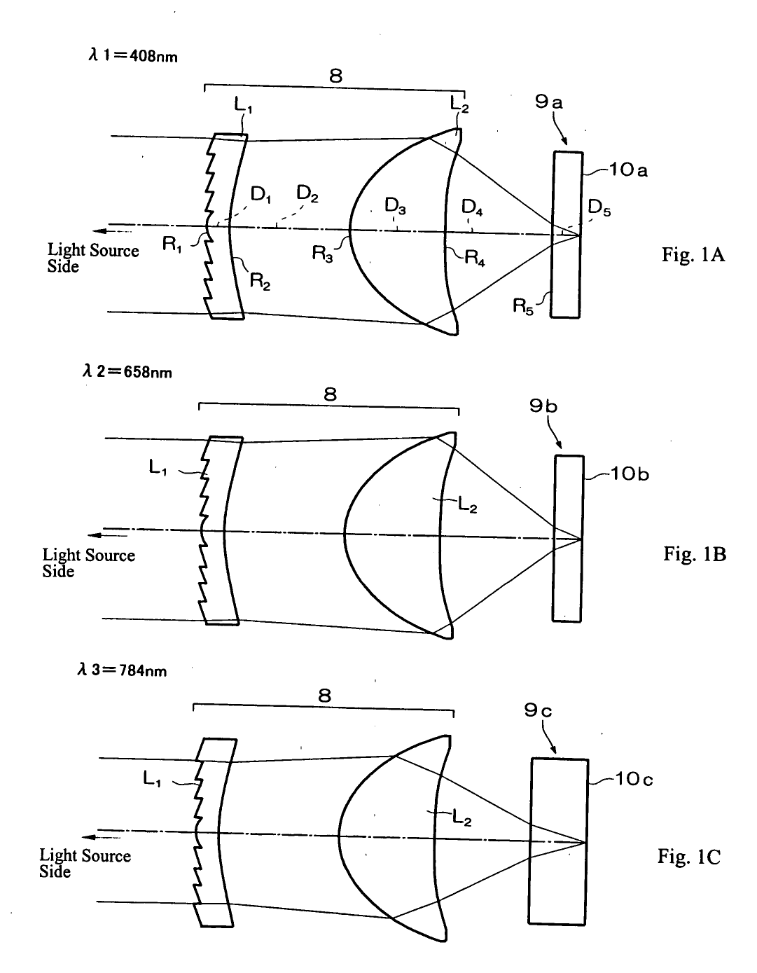

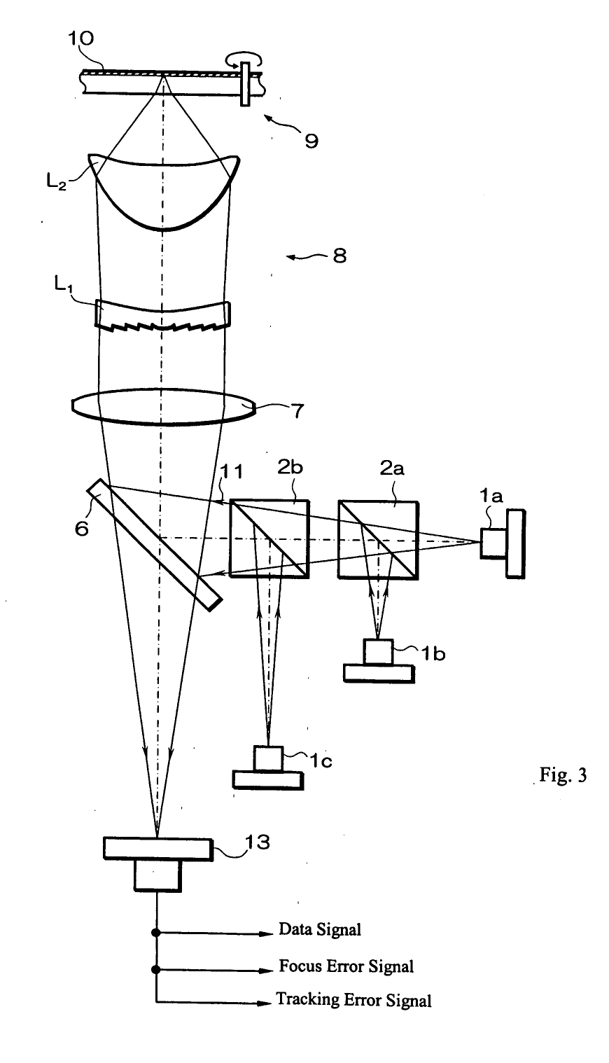

The invention will now be discussed in general terms with reference to FIGS. 1A-1C that show the geometry of the objective optical system of an embodiment of the present invention and FIG. 3 that shows an optical pickup device using the objective optical system of this embodiment. The figures show the elements of the objective optical system schematically. In order to prevent FIG. 3 from being too complicated, only one pair of light rays from each light beam are illustrated at every location of the objective optical system in FIG. 3, even where light of more than one wavelength is present, including at the prisms 2a and 2b. Additionally, in FIGS. 1A-1C and FIG. 3, a diffractive surface is shown as exaggerated in terms of an actual serrated shape in order to more clearly show the diffractive nature of the surface.

As shown in FIG. 3, a laser beam 11 that is emitted from one of the semiconductor lasers 1a, 1b, and 1c is reflected by a half mirror 6, is collimated by a collimator lens 7, and is focused by the objective optical system 8 onto a recording area 10 of an optical recording medium 9. Hereinafter, the term “collimated” means that any divergence or convergence of the light beam is so small that it can be neglected in computing the image-forming properties of the objective optical system 8 for the light beam. The laser beam 11 is converted to a convergent beam by the objective optical system 8 so that it is focused onto the recording region 10 of the optical recording medium 9.

More specifically, as shown in FIGS. 1A-1C, the arrangement includes an optical recording medium 9a that is an AOD with a substrate thickness T1 of 0.6 mm used with a light beam of wavelength λ1 that is equal to 408 nm and with a numerical aperture NA1 of 0.65 (FIG. 1A), an optical recording medium 9b that is a DVD with a substrate thickness T2 of 0.6 mm used with a light beam of wavelength λ2 that is equal to 658 nm and with a numerical aperture NA2 of 0.65 (FIG. 1B), and an optical recording medium 9c that is a CD with a substrate thickness T3 of 1.2 mm used with a light beam of wavelength λ3 that is equal to 784 nm and with a numerical aperture NA3 of 0.51 (FIG. 1C).

The semiconductor laser 1a emits the visible laser beam having the wavelength of approximately 408 nm (λ1) for AODs. The semiconductor laser 1b emits the visible laser beam having the wavelength of approximately 658 nm (λ2) for DVDs. The semiconductor laser 1c emits the near-infrared laser beam having the wavelength of approximately 784 nm (λ3) for CDs such as CD-R (recordable optical recording media) (hereinafter the term CD generally represents CDs of all types).

The arrangement of FIG. 3 does not preclude semiconductor lasers 1a-1c providing simultaneous outputs. However, it is preferable that the lasers be used alternately depending on whether the optical recording media 9 of FIG. 3 is specifically, as shown in FIGS. 1A-1C, an AOD 9a, a DVD 9b, or a CD 9c. As shown in FIG. 3 the laser beam output from the semiconductor lasers 1a, 1b irradiates the half mirror 6 by way of prisms 2a, 2b, and the laser beam output from the semiconductor laser 1c irradiates the half mirror 6 by way of the prism 2b.

The collimator lens 7 is schematically shown in FIG. 3 as a single lens element. However, it may be desirable to use a collimator lens made up of more than one lens element in order to better correct chromatic aberration of the collimator lens 7. In general, the constitution of the objective optical system is illustrated as simply as possible in terms of lens elements in FIGS. 1A-1C. Definitions of the terms “lens element” and “lens component” that relate to this detailed description will now be given. The term “lens element” is herein defined as a single transparent mass of refractive material having two opposed refracting surfaces, which surfaces are positioned at least generally transversely of the optical axis of the collimator lens. The term “lens component” is herein defined as (a) a single lens element spaced so far from any adjacent lens element that the spacing cannot be neglected in computing the optical image forming properties of the lens elements or (b) two or more lens elements that have their adjacent lens surfaces either in full overall contact or overall so close together that the spacings between adjacent lens surfaces of the different lens elements are so small that the spacings can be neglected in computing the optical image forming properties of the two or more lens elements. Thus, some lens elements may also be lens components. Therefore, the terms “lens element” and “lens component” should not be taken as mutually exclusive terms. In fact, the terms may frequently be used to describe a single lens element in accordance with part (a) above of the definition of a “lens component.”

In accordance with the definitions of “lens component,” and “lens element” above, lens elements may also be lens components. Thus, the present invention may variously be described in terms of lens elements or in terms of lens components. Additionally, a “lens” not otherwise limited to being a single lens element or a single lens component may be made of a plurality of lens elements or lens components, the latter of which may in turn be made of a plurality of lens elements. Thus, the collimator lens may be made up of a plurality of lens components rather than being a single lens element as shown in FIG. 3.

Additionally, a diffractive surface may be formed on a surface of a lens element. In this case, whether the lens element with the diffractive surface has an air space on each side to thereby define a lens component or contacts the surface of another lens element with the same curvature to form part or the whole of a lens component made of a plurality of lens elements, the lens component, which includes the diffractive surface, is also herein defined as a diffractive optical element. Thus, the term “diffractive optical element” may refer to a single lens element that includes at least one diffractive surface or to a lens component that includes a plurality of lens elements and that includes at least one diffractive surface. That is, the term “diffractive optical element” may refer, based on the presence of a diffractive surface, (1) to a lens element that is also a lens component, (2) to a lens element that is one of a plurality of lens elements of a lens component, or (3) to a lens component that includes a plurality of lens elements.

In the optical pickup device of the present invention, three collimated light beams of three different wavelengths are incident onto the objective lens system 8. Each of the optical recording media 9, as shown in FIG. 3, whether an AOD 9a, a DVD 9b or a CD 9c shown in FIGS. 1A-1C, respectively, must be arranged at a predetermined position along the optical axis, for example, on a turntable, so that the recording region 10 of FIG. 3 (one of recording regions 10a, 10b, and 10c of an AOD 9a, a DVD 9b and a CD 9c of FIGS. 1A-1C, respectively) is positioned at the focus of the light beam of the corresponding wavelength (λ1, λ2, and λ3 for recording regions 10a, 10b, and 10c, respectively) in order to properly record signals and reproduce recorded signals.

In the recording region 10, pits carrying signal information are arranged in tracks. The reflected light of a laser beam 11 is made incident onto the half mirror 6 by way of the objective optical system 8 and the collimator lens 7 while carrying the signal information, and the reflected light is transmitted through the half mirror 6. The transmitted light is then incident on a four-part photodiode 13. The respective quantities of light received at each of the four parts of the four-part photodiode 13 are converted to electrical signals that are operated on by calculating circuits (not shown in the drawings) in order to obtain data signals and respective error signals for focusing and tracking.

Because the half mirror 6 is inserted into the optical path of the return light from the optical recording media 9 at a forty-five degree angle to the optical axis, the half mirror 6 introduces astigmatism into the light beam, as a cylindrical lens may introduce astigmatism, whereby the amount of focusing error may be determined according to the form of the beam spot of the return light on the four-part photodiode 13. Also, a grating may be inserted between the semiconductor lasers 1a-1c and the half mirror 6 so that tracking errors can be detected using three beams.

As shown in FIGS. 1A-1C and FIG. 3, the objective optical system 8 of the present invention includes, in order from the light source side, a diffractive optical element L₁, with one surface being a diffractive surface and the other surface being a refractive surface, which is a concave surface as shown in FIGS. 1A-1C, and an objective lens L₂ of positive refractive power. As discussed above with regard to the collimator lens 7, the objective lens L₂ is shown in FIG. 3 (as well as in FIGS. 1A-1C) as a single lens element, but may be formed of a plurality of lens elements or lens components. The diffractive surface is defined by the phase function Φ. The objective optical system 8 is also constructed so that the air spacings between the diffractive optical element L₁ and the objective lens L₂ are equal to one another when any one of the optical recording medium 9, the AOD 9a, the DVD 9b or the CD 9c, is selected.

Generally, when parallel light beams for two kinds of optical recording media are used, it is considered possible to converge each light beam to a prescribed desired position while obtaining satisfactory aberration correction for both light beams by using an appropriate diffractive optical element for diffractive optical element L₁. For example, with specific reference to FIGS. 1A-1C, the AOD 9a and the DVD 9b with the same substrate thickness of the optical recording medium of 0.6 mm can be constructed so as to have prescribed converging actions different from each other during recording or reproducing of respective information by providing the diffractive optical component L₁ with an appropriate prescribed diffractive surface so as to optimize the correction of aberrations, such as spherical aberration, with the light beams incident on the objective optical system 8 being collimated.

Here, if a collimated light beam for still another kind of optical recording medium is made incident, spherical aberration of this collimated light beam may easily become excessive for the light beam, which may have a different wavelength, and it is difficult to focus this light beam to a prescribed position with satisfactory aberration correction. However, the present invention enables focusing three light beams to prescribed positions with satisfactory aberration correction for three different optical recording media with the air space between the diffractive optical component L₁ and the positive lens L₂ being the same. That is, namely, as shown in FIGS. 1A-1C, the air space between the diffractive optical component L, and the positive lens L₂ for the CD 9c with a large substrate thickness of the recording medium of 1.2 mm becomes equal to the air space for the AOD 9a and the DVD 9b, and the correction of aberrations, such as spherical aberration, is optimized for collimated light beams entering into the objective optical system 8 by designing the diffracting power of the diffractive optical element L₁ and the refractive power of the objective lens L₂ so as to compensate for aberrations generated due to differences in wavelengths of the light beams, in numerical apertures of the light beams, and in the substrate thickness of the different optical recording media.

When any of said optical recording media is selected, the burden of mechanical control of the objective optical system 8 can be reduced and the construction made more compact simply by constructing the objective optical system 8 so that the air spaces between the diffractive optical element L₁ and the objective lens L₂ become equal for all the recording media. If the diffractive optical element L1 and the objective lens L2 are constructed so as to move as a monolithic one-piece unit, a driving part becomes simpler and has a more compact construction.

According to the objective optical system 8 of the present invention, the degree of freedom in the lay-out of the optical system can be increased in order to achieve greater compactness and improve the tracking stability when recording or reproducing of information is performed for any of the optical recording media (i.e., the AOD 9a, the DVD 9b or the CD 9c) because a collimated light beam always enters the objective optical system 8. Additionally, with regard to problems related to oblique incidence of light rays into diffraction grooves of the diffractive surface of the diffractive optical element, the diffraction efficiency of the light used can be improved by using incident collimated light.

The diffractive optical element L₁ can extend the working distance by having negative refractive power as a whole, which helps prevent the collision of the objective lens L₂ and the recording disk.

The diffractive surface of the diffractive optical element L₁ in the objective optical system 8 preferably is designed so that the diffractive optical surface diffracts light of maximum intensity for the first wavelength λ1 at a diffraction order that is different from the diffraction order of maximum intensity for the second wavelength λ2 and that is different from the diffraction order of maximum intensity for the third wavelength λ3. The three light beams can be focused to appropriate desired diffraction efficiency by setting the diffraction orders of maximum intensity diffracted light as described above.

Even more preferably, the diffractive optical surface is designed so that it diffracts light of the first wavelength λ1 with maximum intensity in a second-order diffracted beam, diffracts light of the second wavelength λ2 with maximum intensity in a first-order diffracted beam, and diffracts light of the third wavelength λ3 with maximum intensity in a first-order diffracted beam. By selecting the diffraction orders in this manner, the diffraction grooves of the diffractive optical surface can be made shallow, and all three light beams can be converged with high diffraction efficiency without applying an excessive burden on metal mold processing and/or the shaping of the refractive surfaces.

For example, in an objective optical system 8 for optical recording media described more specifically later, the diffractive surface is designed so as to maximize the quantity of second-order diffracted light for a light beam of wavelength 408 nm (λ1) corresponding to AOD 9a, to maximize the quantity of first-order diffracted light for a light beam of wavelength 658 nm (λ2) corresponding to DVD 9b, and to maximize the quantity of first-order diffracted light for a light beam of wavelength 784 nm (λ3) corresponding to CD 9c.

In an optical pickup device described in Japanese Laid-Open Patent Application 2001-195769, a construction using collimated light beams entering the objective optical system for all the light beams being used with the optical recording media of the next generation of high-density optical disks, such as AODs, DVDs and CD, by using an objective lens of one-piece construction having a diffractive surface on at least one face has been proposed as a well known approach. This construction can use the three collimated light beams entering the objective optical system to illuminate the three optical recording media with a single objective lens of simple construction. This construction enables improving the correction of spherical aberration associated with differences in substrate thicknesses of the optical recording media and the chromatic aberration generated in this objective lens. However, it becomes very difficult to improve the diffraction efficiency of the diffracted light used because the diffraction order of each diffracted light beam diffracted by the diffractive optical element is not specifically considered, and thus diffracted light of the same diffraction order are used as the focused light beams for all the recording media. In contrast, according to the present invention, a high diffraction efficiency can be achieved by the diffraction orders of the three light beams being used not being all the same, and thus the present invention is highly practical.

Moreover, it is preferable that the diffractive surface of the objective optical system 8 of the present invention be formed as a diffractive structure on a ‘virtual plane’, herein defined as meaning that the surface where the diffractive structure is formed would be planar but for the diffractive structures of the diffractive surface, and that the virtual plane be perpendicular to the optical axis. Preferably, the cross-sectional configuration of the diffractive surface is serrated so as to define a so-called kinoform. FIGS. 1A-1C and FIG. 3 exaggerate the actual size of the serrations of the diffractive surfaces.

The diffractive surface adds a difference in optical path length equal to m·λ·Φ/(2π) to the diffracted light, where λ is the wavelength, Φ is the phase function of the diffractive optical surface, and m is the order of the diffracted light that is focused on a recording medium 9. The phase function Φ is given by the following equation:
Φ=ΣWᵢ·Y²ⁱ Equation (A)
where
Y is the distance in mm from the optical axis; and
Wᵢ is a phase function coefficient, and the summation extends over i.

The specific heights of the serrated steps of the diffractive surface of the diffractive optical element L₁ are based on ratios of diffracted light of each order for the light beams of different wavelengths λ1, λ2, and λ3. Additionally, the outer diameter of the diffractive surface can be determined by taking into consideration the numerical aperture (NA) of the objective optical system 8 and the beam diameter of the incident laser beam 11 of each of the three wavelengths.

It is preferable that at least one surface of the objective optical system 8 of the present invention, including the objective lens L₂, be an aspheric surface. It is also preferable that the aspheric surfaces of the objective optical system 8 of the present invention be rotationally symmetric aspheric surfaces defined using the following aspherical equation in order to improve aberration correction for all the recording media 9a, 9b, and 9c and in order to assure proper focusing during both recording and reproducing operations:
Z=[(C·Y²)/{1+(1−K·C²·Y²)^{1/2}}]+ΣAᵢ·Y²ⁱ Equation (B)
where
Z is the length (in mm) of a line drawn from a point on the aspheric lens surface at a distance Y from the optical axis to the tangential plane of the aspheric surface vertex,
C is the curvature (=1/the radius of curvature, R in mm) of the aspheric lens surface on the optical axis,
Y is the distance (in mm) from the optical axis,
K is the eccentricity, and
Aᵢ is an aspheric coefficient, and the summation extends over i.

It is preferable that the diffractive surface formed on the diffractive optical element L₁ and the rotationally symmetric aspheric surface formed on the objective lens L₂ are determined to focus each of the three beams of light with the three wavelengths, λ1, λ2, and λ3, on a corresponding recording region 10, as shown in FIG. 3 (10a, 10b, 10c, as shown in FIGS. 1A-1C, respectively) with excellent correction of aberrations.

Additionally, in the objective optical system 8 of the present invention, the diffractive optical element L₁ and the objective lens L₂ may either one or both be made of plastic. Making these optical elements of plastic is advantageous in reducing manufacturing costs and making manufacturing easier, and in making the system lighter, which may assist in high speed recording and reproducing. In particular, using a mold makes manufacture of the diffractive optical element much easier than many other processes of manufacturing.

Alternatively, one or both of the diffractive optical element L₁ and the objective lens L₂ may be made of glass. Glass is advantageous for several reasons: it generally has optical properties that vary less with changing temperature and humidity than for plastic; and appropriate glass types are readily available for which the light transmittance decreases less than for plastic, even at relatively short wavelengths over a long duration of time.

An embodiment of the objective optical system 8 of the present invention will now be set forth in detail.

FIGS. 1A-1C are schematic diagrams that depict cross-sectional views of the objective optical system of this embodiment of the present invention, with FIG. 1A showing the operation of the objective optical system when used with the optical recording medium 9a, with FIG. 1B showing the operation of the objective optical system when used with a second optical recording medium 9b, and with FIG. 1C showing the operation of the objective optical system when used with a third optical recording medium 9c. As shown in FIGS. 1A-1C, the objective optical system of the present invention includes, in order from the light source side, a diffractive optical element L₁ having negative refractive power and with the surface on the light source side being a diffractive surface formed as a diffractive structure on a virtual plane that is perpendicular to the optical axis and the surface on the recording medium side being a rotationally symmetric aspheric concave surface, and an objective lens L₂ that is a meniscus lens element with its convex surface on the light source side and with two rotationally symmetric aspheric surfaces. The diffractive surface being formed as a diffractive structure on a virtual plane means that the surface where the diffractive structure is formed is planar but for the diffractive structures of the diffractive surface, and the virtual plane is perpendicular to the optical axis. The diffractive surface is defined by the phase function Φ defined by Equation (A) above and the rotationally symmetric aspheric surfaces are defined by Equation (B) above. The diffractive surface is formed with a cross-sectional configuration of concentric serrations that define a grating.

As indicated in FIGS. 1A-1C, the objective optical system 8 favorably focuses light of each wavelength, λ1 of 408 nm, λ2 of 658 nm, and λ3 of 784 nm, onto a respective recording region 10a, 10b, or 10c of respective recording media 9a, 9b, and 9c, which are an AOD, a DVD, and a CD, respectively. Additionally, as shown in FIGS. 1A-1C, the objective lens operates with an infinite conjugate on the light source side with the substantially collimated light beams of all three wavelengths being incident on the objective optical system 8.

Table 1 below lists the surface #, in order from the light source side, the surface type or radius of curvature (in this case, the radii of curvature are given for planar surfaces, which have a radius of curvature of infinity), the on-axis distance (in mm) between surfaces for the three used wavelengths (λ1=408 nm for the AOD 9a, λ2=658 nm for the DVD 9b, and λ3=784 nm for the CD 9c), and the refractive indexes at the three used wavelengths.

TABLE 1

| | Surface Type or | On Axis Surface Spacing | | | Refractive Index | | |
|---|---|---|---|---|---|---|---|
| # | Radius of Curvature | λ1 = 408 nm | λ2 = 658 nm | λ3 = 784 nm | λ1 = 408 nm | λ2 = 658 nm | λ3 = 784 nm |
| 1 | diffractive | 0.500 | 0.500 | 0.500 | 1.55636 | 1.54076 | 1.53704 |
| 2 | aspheric | 2.600 | 2.600 | 2.600 | 1.00000 | 1.00000 | 1.00000 |
| 3 | aspheric | 2.060 | 2.060 | 2.060 | 1.55636 | 1.54076 | 1.53704 |
| 4 | aspheric | 2.321 | 2.460 | 2.075 | 1.00000 | 1.00000 | 1.00000 |
| 5 | ∞ | 0.600 | 0.600 | 1.200 | 1.61800 | 1.57800 | 1.57200 |
| 6 | ∞ | | | | | | |

Table 2 below lists, for each used wavelength, the diaphragm diameter DD (in mm), the focal length f (in mm), the numerical aperture NA, the apparent light source position, and the diffraction order of the diffracted light that is used for the objective optical system of Table 1.

TABLE 2

| | λ1 = 408 nm | λ2 = 658 nm | λ3 = 784 nm |
|---|---|---|---|
| diaphragm diameter, DD | 3.89 | 4.05 | 3.21 |
| focal length, f | 3.00 | 3.12 | 3.15 |
| numerical aperture, NA | 0.65 | 0.65 | 0.51 |
| light source position | ∞ | ∞ | ∞ |
| diffraction order used | 2 | 1 | 1 |

The diffractive optical surface of the diffractive optical element L₁ includes concentric gratings with a serrated cross-section, and, as described above, is formed so as to maximize the quantity of diffracted light of second-order for a laser beam of wavelength λ1 of 408 nm for use with an AOD, so as to maximize the quantity of diffracted light of first-order for a laser beam of wavelength λ2 of 658 nm for use with a DVD, and so as to maximize the quantity of diffracted light of first-order for a laser beam of wavelength λ3 of 784 nm for use with a CD.

Table 3 below lists the values of the curvature C, the eccentricity K, and the aspheric coefficients A₂-A₅ for each aspheric surface of this embodiment, in order from the light source side that are used in Equation (B) above. An “E” in the data indicates that the number following the “E” is the exponent to the base 10. For example, “1.0E-2” represents the number 1.0×10⁻². Aspheric coefficients that are not listed in Table 3 are zero.

TABLE 3

| | 2^{nd} Surface | 3^{rd} Surface | 4^{th} Surface |
|---|---|---|---|
| C | 2.855055566E−1 | 6.397667585E−1 | 1.917736121E−2 |
| K | 1.444380429 | 2.303441776E−1 | −4.305096388E−2 |
| A₂ | −3.926063651E−2 | −3.917804933E−3 | 3.392506786E−2 |
| A₃ | 7.558914966E−3 | 1.125793204E−3 | −6.018250510E−3 |
| A₄ | −6.597769086E−4 | 1.800235521E−4 | 2.838747063E−4 |
| A₅ | −1.764025590E−5 | 1.081973660E−5 | 1.264162466E−5 |

Table 4 below lists the values of the phase function coefficients W₁-W₅ that are used in Equation (A) above for the first surface (i.e., the surface on the light source side) that forms a diffractive surface of the objective optical system of this embodiment. Phase function coefficients not listed in Table 4 are zero. Once again, an “E” in the data indicates that the number following the “E” is the exponent to the base 10.

TABLE 4

| | |
|---|---|
| W₁ | −7.562749209E+1 |
| W₂ | 5.532819727E−1 |
| W₃ | −3.443194969E−1 |
| W₄ | −1.626855876 |
| W₅ | 2.655052464E−1 |

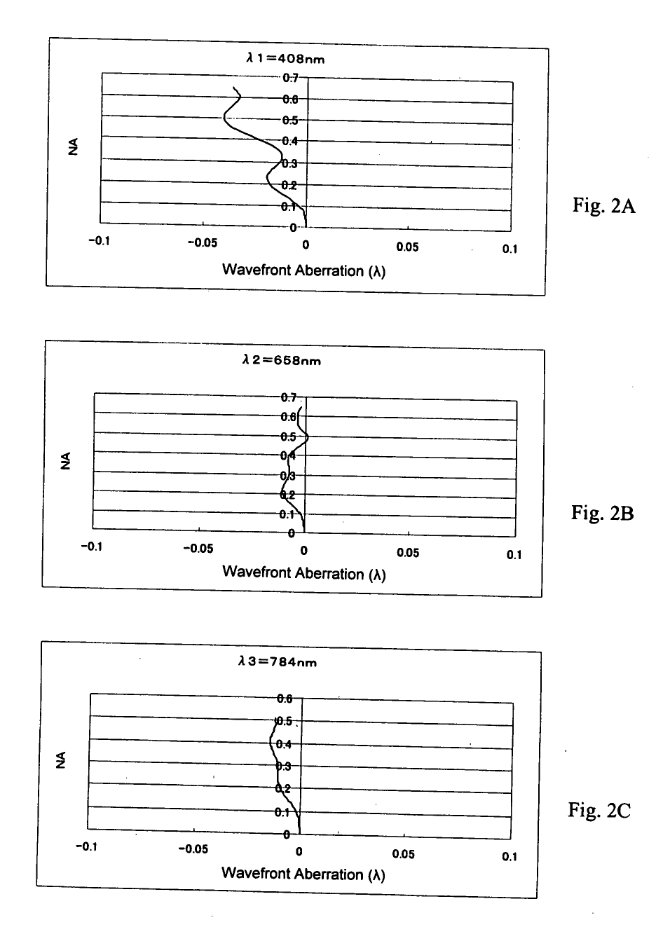

FIGS. 2A-2C illustrate wavefront aberration profiles of the light beams of three wavelengths being focused to a spot by the objective optical system of this embodiment of the present invention, with FIG. 2A illustrating the wavefront aberration profile of the light beam of the first wavelength λ1 being focused to a spot for the first optical recording medium 9a which is an AOD, with FIG. 2B illustrating the wavefront aberration profile of the light beam of the second wavelength λ2 being focused to a spot for the second optical recording medium 9b which is a DVD, and with FIG. 2C illustrating the wavefront aberration profile of the light beam of the third wavelength λ3 being focused to a spot for the third optical recording medium 9c which is a CD. As shown by FIGS. 2A-2C, the wavefront aberrations are favorably corrected for all three light beams. Additionally, the objective optical system 8 and the optical recording media 9a, 9b, and 9c are arranged so that Conditions (1)-(3) described above are satisfied and the distances between the diffractive optical component L₁ and the positive lens L₂ are all equal to 2.6 mm during recording or reproducing of information to/from all the optical recording media (i.e., AOD 9a, DVD 9b and CD 9c).

The objective optical system for optical recording media of the present invention being thus described, it will be obvious that it may be varied in many ways.

For example, in the objective optical system for optical recording media of the present invention, the diffractive optical element L₁ and the objective lens L₂ are separated at equal distances during recording and reproducing at all three wavelengths, as described above. However, the air space between the diffractive optical element L₁ and the objective lens L₂ may be varied in order, for example, to obtain fine adjustment from this reference position for better correction of spherical aberration associated with variations in substrate thicknesses due to tolerances of substrate thicknesses in individual optical recording media or associated with different substrate thicknesses, such as with multilayer recording media disks with different substrate thicknesses.

Additionally, the diffractive optical element and/or the objective lens may be supported so that it can be inclined relative to the optical axis in order to compensate, for example, for inclination of an optical recording medium.

Furthermore, the diffractive optical element of the embodiment described above has a diffractive structure arranged on a virtual plane on the light source side and a rotationally symmetric aspheric surface on the optical recording medium side, but the diffractive optical element is not limited to such a construction. For example, the diffractive surface may be formed on a convex or concave surface having refractive power and may be formed on an aspheric surface. The surface of the diffractive optical element on the light source side may be a rotationally symmetric aspheric surface and the surface of the diffractive optical element on the optical recording medium side may be a diffractive surface. In the embodiment of the present invention described above, a rotationally symmetric aspheric surface is used as the surface that is not the diffractive surface, but it may also be changed and be a planar surface, a spherical surface, or a non-rotationally symmetric aspheric surface. It is also possible that the diffractive surface be formed on a surface having refractive power and the other surface of the diffractive optical element be planar. Both surfaces of the diffractive optical component may also be diffractive surfaces.

The diffractive optical surface of the objective optical system should be constructed so as to output a considerable quantity of diffracted light of the desired orders of diffracted light for the appropriate wavelengths, with 100% diffracted light of each appropriate order being the ideal. Additionally, the structure of the diffractive optical element is not limited to the serrated one, but, for example, a stair stepped structure may also be used.

Additionally, the objective lens of the objective optical system is not limited to a construction wherein both the surface on the light source side and the surface on the optical recording medium side are rotationally symmetric aspheric surfaces, or to the objective lens having a meniscus shape. For example, planar, spherical, or non-rotationally symmetric aspheric surfaces may be used in general.

Furthermore, the optical recording media to be recorded and reproduced in the optical pickup device of the present invention are not restricted to an AOD, a DVD and a CD. The present invention relates generally to use with the optical recording media where Conditions (1)-(3) are satisfied. For example, instead of a design based on AOD recording and reproducing at one of the three wavelengths, a design may be based on Blu-ray technology, which may be used with a numerical aperture of 0.85, a Blu-ray disk substrate thickness of 0.1 mm and a light beam having a wavelength of 405 nm. The present invention can be used in an objective optical system for optical recording media to converge light beams to desirable positions for each of the first optical recording medium corresponding to the first numerical aperture and the first wavelength, the second optical recording medium corresponding to the second numerical aperture and the second wavelength, and the third optical recording medium corresponding to the third numerical aperture and the third wavelength when making the recording or reproducing of information.

Additionally, the size relationships among the used light wavelengths, the numerical apertures, and the substrate thicknesses are not limited to those of Conditions (1)-(3) described above. Even when the optical recording media being used are AODs, DVDs and CDs, as described above, the wavelengths of the light beams being used are not limited to those described in the embodiment above. Light of wavelengths other than the wavelength of 408 nm for the AOD, other than the wavelength of 658 nm for the DVD, and/or other than the wavelength of 784 nm for the CD can be used if it satisfies the recording and/or reproducing characteristics of a particular optical recording medium. Similar considerations apply to variations in numerical apertures of the objective optical system for a given light beam with a given wavelength and to variations in disk thicknesses for optical recording media used with a given light beam of a given wavelength. Probably, optical recording media with characteristics other than those described above will be developed in the future, such as, optical recording media using even shorter wavelengths, and the present invention encompasses such developments. In any case, a material having a good transmittance for light of the wavelength being used is preferable for use as the material that forms the lens elements and the diffractive optical element. For example, fluorite or quartz may be used as a lens material and a diffractive optical element material of the objective optical system for optical recording media of the present invention for light beams of appropriate wavelengths.

Also, the objective optical system for optical recording media of the present invention is readily applicable to devices using four or more optical recording media.

Additionally, although in the optical pickup device described above three light sources that output light beams having wavelengths that differ from each other are used, a single light source that outputs two light beams having wavelengths different from each other can be used as a light source. For example, light of different wavelengths may be emitted from adjacent output ports. In such a case, instead of using prisms 2a and 2b as shown in FIG. 3, a single prism may be used in order to combine the light beams. Furthermore, in this optical pickup device, an aperture and/or aperture control device that has a wavelength selectivity may be arranged at the light source side of the objective optical system. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

1. An objective optical system for focusing light from a light source onto optical recording media, the objective optical system comprising, in order from the light source side along an optical axis:
a diffractive optical element having a diffractive surface on at least one side; and
an objective lens having positive refractive power;
wherein
the objective optical system is configured to receive a collimated light beam of a first wavelength λ1 on its light source side and focus diffracted light diffracted by the diffractive surface of the diffractive optical element at a first numerical aperture NA1 onto a desired portion of a first optical recording medium having a substrate thickness T1 when the distance along the optical axis between the diffractive optical element and the objective lens is a certain distance, to receive a collimated light beam of a second wavelength λ2 on its light source side and focus diffracted light diffracted by the diffractive surface of the diffractive optical element at a second numerical aperture NA2 onto a desired portion of a second optical recording medium having a substrate thickness T2 when the distance along the optical axis between the diffractive optical element and the objective lens is said certain distance, and to receive a collimated light beam of a third wavelength λ3 on its light source side and focus diffracted light diffracted by the diffractive surface of the diffractive optical element at a third numerical aperture NA3 onto a desired portion of a third optical recording medium having a substrate thickness T3 when the distance along the optical axis between the diffractive optical element and the objective lens is said certain distance.

2. The objective optical system according to claim 1, wherein said diffractive optical element has negative refractive power.

3. The objective optical system according to claim 1, wherein the following conditions are satisfied:
λ1<λ2<λ3
NA1≧NA2>NA3
T1≦T2<T3.

4. The objective optical system according to claim 1, wherein the diffractive optical surface diffracts light of maximum intensity for the first wavelength λ1 at a diffraction order that is different from the diffraction order of maximum intensity for the second wavelength λ2 and that is different from the diffraction order of maximum intensity for the third wavelength λ3.

5. The objective optical system of claim 4, wherein the diffractive optical surface:
diffracts light of the first wavelength λ1 with maximum intensity in a second-order diffracted beam;
diffracts light of the second wavelength λ2 with maximum intensity in a first-order diffracted beam; and
diffracts light of the third wavelength λ3 with maximum intensity in a first-order diffracted beam.

6. The objective optical system of claim 1, wherein the diffractive surface is formed as a diffractive structure on a virtual plane that is perpendicular to the optical axis of the objective optical system.

7. The objective optical system of claim 1, wherein the diffractive optical element is made of plastic.

8. The objective optical system of claim 1, wherein the diffractive optical element is made of glass.

9. The objective optical system of claim 1, wherein the objective lens is made of plastic.

10. The objective optical system of claim 1, wherein the objective lens is made of glass.

11. The objective optical system of claim 1, wherein at least one surface of the objective lens is an aspheric surface.

12. The objective optical system of claim 11, wherein the aspheric surface is a rotationally symmetric aspheric surface.

13. The objective optical system of claim 1, wherein:
the first optical recording medium is an AOD;
the second optical recording medium is a DVD; and
the third optical recording medium is a CD.

14. An optical pickup device that includes the objective optical system according to claim 1.

15. An optical pickup device that includes the objective optical system according to claim 2.

16. An optical pickup device that includes the objective optical system according to claim 3.

17. The objective optical system of claim 1, wherein the diffractive optical element is a lens element that is a first lens component.

18. The objective optical system of claim 17, wherein the objective optical system consists of said first lens component and the objective lens.

19. The objective optical system of claim 17, wherein the objective lens is a lens element that is a second lens component.

20. The objective optical system of claim 19, wherein the objective optical system consists of said first lens component and said second lens component.
